(19) United States
(12) Patent Application Publication
(10) Pub. No.: US 2010/0265063 A1
(43) Pub. Date: Oct. 21, 2010

(54) BLASTING DEVICE

(75) Inventor: Oddbjorn Eken, Prestfoss (NO)

Correspondence Address: VOLPE AND KOENIG, P.C., UNITED PLAZA, 30 SOUTH 17TH STREET, PHILADELPHIA, PA, 19103, US

(73) Assignee: VIKING TECHNOLOGY AS, Prestfoss (NO)

(21) Appl. No.: 12/674,606

(22) PCT Filed: Aug. 19, 2008
(86) PCT No.: PCT/NO2008/000294

§ 371 Date: Feb. 22, 2010

(30) Foreign Application Priority Data
Aug. 21, 2007 (NO) 20074268

(51) Int. Cl. G08B 1/08

(52) U.S. Cl. 340/539.32

(57) ABSTRACT

The present invention provides a system, method and device for locating undetonated explosive devices during the clean-up of a blasting area, the location being effected by co-locating in active or passive wireless transmitter units together with the respective explosive devices, and where the location is effected by at least one radio receiver unit that is in radio communication with the respective wireless transmitter units, where the wireless transmitter unit changes its radio frequency characteristic as a blasting operation causes destruction of the wireless transmitter unit, or in that a device in the wireless transmitter unit detects that the explosive device and the wireless transmitter unit have become separated at the blast site.

The present invention relates to tracking explosive devices. More specifically, the invention relates to a system, method and device for locating undetonated explosive devices during the clean-up of a blasting area.

During the clean-up of blast debris after a blasting operation there is a potential danger that a clean-up means, for example, a digger or wheel loader, may cause the explosion of undetonated explosives in the blast debris as the clean-up means starts to remove the debris. This constitutes a huge danger to both personnel and equipment, and it is therefore extremely important to be able to locate undetonated explosive devices in the blast debris before and preferably also during the clean-up operation.

A borehole in an open-cast mine or quarry is typically 15 meters deep, and the charging of the borehole functions such that an explosive device with an initiator attached at the bottom thereof is lowered into the borehole. The borehole is then filled with explosive in liquid or powder form, e.g. slurry or anolyte, and a top explosive device with initiator is subsequently lowered into place. When blasting in a tunnel, the borehole is typically 5 meters deep, and then it is usual to use only one explosive device with initiator attached at the bottom thereof, and the borehole is filled with liquid explosive material, usually slurry. The initiators that are attached to the explosive devices are usually electric initiators or Nonel-type initiators. When electric initiators are used, current and the resistivity in the circuit can be measured to check whether the circuit is in order. However, electric initiators are sensitive to external electric fields, e.g., high-voltage masts, and can be triggered by accident. Therefore, it is preferable to use Nonel-type initiators. Nonel-type initiators are tubes with a thin layer of ignitable explosive compound in the tube. A common problem in connection with Nonel-type initiators, especially for bottom charges, is that a bend in the tube may prevent the firing from reaching the explosive device. One possible scenario therefore is that the top charge and the explosive in liquid or powder form goes off, but that an explosive device with initiator still remains at the bottom of the borehole. The explosive device per se constitutes a danger to personnel and equipment during the clean-up of the blast debris, but the danger is far greater if the initiator also is intact.

Inspection of the blast debris is usually done visually by personnel with appropriate training, the visual inspection comprising looking for cut-offs, remaining parts with holes, for example, stone blocks with boreholes, and visible undetonated explosive devices. In, for example, an open-cast mine or quarry that produces about 500,000 tonnes of mass per annum, shots are usually fired which result in blast debris that is about 30 m wide, 40 m long and about 12 m high. The visual inspection is time-consuming, requires a great deal of experience and covers only the uppermost masses. There is therefore a need for a simple system, method and device which permit efficient location of undetonated explosive devices in the blast debris before and during clean-up of the blast debris.

US 2007/0008115 teaches a system and method for detecting, monitoring, tracking and identifying explosive materials using active or passive RFID chips inside or on the explosive materials.

One aspect of the present invention is to provide a method for locating undetonated explosive devices during the clean-up of a blasting area, where a plurality of active or passive wireless transmitter units are used, the respective wireless transmitter units being co-located with the respective explosive devices, and where the location of the explosive devices is effected by at least one radio receiver unit that is in radio communication with the respective wireless transmitter units. In one exemplary embodiment according to the invention, the undetonated explosive devices are located by searching for a wireless transmitter unit using the at least one radio receiver unit, the wireless transmitter unit having changed radio frequency characteristic as a blasting has destroyed the wireless transmitter unit, or in that a device in the wireless transmitter unit has detected that the explosive device and the wireless transmitter unit have become separated at the blast site as a result of the blasting.

In an exemplary embodiment according to the invention, an initiator for the explosive device is joined to the wireless transmitter unit. The wireless transmitter unit can, for example, be positioned adjacent to the initiator, in proximity to the initiator or be an integral part of the initiator. In another exemplary embodiment according to the invention, the wireless transmitter unit is fastened to the initiator using a sleeve.

In an alternative embodiment, the wireless transmitter unit is mounted inside the explosive device.

In another exemplary embodiment according to the invention, the wireless transmitter unit is mounted in two casings formed of a suitable material, the first casing partly surrounding the second casing.

In an exemplary embodiment according to the invention, the two casings are squeezed together to provide electrical contact between a battery and an electric circuit. In this way, the wireless transmitter unit can be activated as it is placed in, e.g., a borehole.

In an alternative embodiment according to the invention, pressure is applied to one of the end faces in order to provide electrical contact between a battery and an electric circuit.

In an exemplary embodiment according to the invention, an antenna is mounted on the wireless transmitter unit, the antenna comprising a coil with a ferrite core. This antenna sets up a magnetic primary field which is only slightly affected by capacitance to the surroundings. In addition, the ferrite core provides an up to 25 times higher flux than a corresponding coil without a core, due to the high permeability of the ferrite.

In an exemplary embodiment according to the invention, is to arrange the ferrite core, the ferrite core having a centred opening, through-going in the longitudinal axis, with a mirror in front of one of the ends of the opening, and an optical sensor and light source in front of the other end of the opening, the light source giving an optical signal to the optical sensor via the mirror. In another embodiment according to the invention, changes in the optical signal are measured as the ferrite core is wholly or partly destroyed, or is bent, and the radio frequency characteristic is changed according to the measurements.

In an alternative embodiment according to the invention, an additional coil is provided at one of the ends of the ferrite core, whereby the wireless transmitter unit measures the field strength of the signal. In an advantageous exemplary embodiment according to the invention, the additional coil is embodied in a circuit board, the circuit board comprising control electronics for the wireless transmitter unit. In a further embodiment according to the invention, changes in the field strength are measured as the ferrite core is wholly or partly destroyed, or is bent, and the radio frequency characteristic is changed according to the measurements.

In an exemplary embodiment, the transmission frequency of the wireless transmitter unit is changed as measurements indicate that the ferrite core has been wholly or partly destroyed or bent

In an alternative exemplary embodiment, the frequency modulation of the wireless transmitter unit is changed as measurements indicate that the ferrite core has been wholly or partly destroyed, or bent.

In an exemplary embodiment, each wireless transmitter unit sends a unique identification signal which identifies the wireless unit. This may be of help in locating the undetonated explosive devices if, for example, the different wireless transmitter units are mapped before a blasting operation. A wireless transmitter unit of this kind may, e.g., be an active or passive RFID chip.

In an exemplary embodiment according to the invention, the wireless units are searched for using triangulation.

In an alternative embodiment according to the invention, the wireless units are searched for using a single wireless radio receiver unit with an antenna directionally oriented towards increasing signal strength.

In an exemplary embodiment, a wireless receiver unit is mounted on a digging implement, e.g., a spade or grab, connected to a clean-up means, e.g., a digger, a wheel loader or a person, whereby an alarm signal is provided as the digging implement approaches the wireless transmitter unit.

A second aspect of the present invention is to provide an explosive device for use in a system for locating undetonated explosive devices during the clean-up of a blasting area, the explosive device comprising an insertable initiator. In an exemplary embodiment according to the invention, a wireless transmitter unit is fastened to the initiator.

In a further exemplary embodiment, the fastening comprises a sleeve.

In an exemplary embodiment, the wireless transmitter unit comprises two casings, formed of a suitable material, the first casing partly surrounding the second casing.

In an exemplary embodiment, the wireless transmitter unit comprises a battery and an electric circuit, and an electrically insulating material is disposed between one of the battery poles and the electric circuit. The insulating material may, e.g., be attached to one or both casing parts in such manner that the insulating material is pulled away from the electric pole as the casings are squeezed together, and provides electrical contact with the electric circuit.

In an alternative exemplary embodiment, the wireless transmitter unit comprises a battery and an electric circuit, where a hook holds a contact of one of the battery poles disconnected from the electric circuit. The hook may, e.g., be fastened to one or both casings in such manner that the contact falls off the hook as the casings are squeezed together, and provides electrical contact with the electric circuit.

In an exemplary embodiment according to the invention, the wireless transmitter unit comprises an antenna, which antenna is a coil with a ferrite core. This antenna sets up a magnetic primary field that is only slightly affected by capacitance to the surroundings. In addition, the ferrite core provides an up to 25 times higher flux than a similar coil without a core, due to the high permeability of the ferrite.

In an exemplary embodiment according to the invention, the ferrite core has a centred opening, through-going in the longitudinal axis. In a further embodiment according to the invention, a mirror is attached in front of one of the ends of the opening and an optical sensor and a light source are attached in front of the other end of the opening.

In an alternative exemplary embodiment according to the invention, one additional coil is provided at one of the ends of the ferrite core. In a further embodiment, the coil is implemented in a circuit board. In yet another embodiment, the circuit board comprises control electronics for the wireless transmitter unit.

In an exemplary embodiment according to the invention, the wireless transmitter unit is an active or passive RFID chip.

A third aspect of the present invention is to provide a system for locating undetonated explosive devices during the clean-up of a blasting area, where a plurality of active or passive wireless transmitter units are used, the respective wireless transmitter units being co-located with the respective explosive devices, and where location of the explosive devices is effected by at least one radio receiver unit which is in radio communication with the respective wireless transmitter units. In an exemplary embodiment according to the invention, the blasting of an explosive device produces a changed radio frequency characteristic in the respective wireless active or passive transmitter unit in that the blasting destroys the wireless transmitter unit, or in that a device in the wireless transmitter unit detects that the explosive device and the respective co-located wireless transmitter unit have become separated at the blast site as a result of the blasting.

In an exemplary embodiment according to the invention the co-location is effected by placing an initiator for the explosive device together with the wireless transmitter unit.

In an exemplary embodiment according to the invention, the wireless transmitter unit is an integral part of the initiator.

In an alternative embodiment according to the invention, the co-location is effected by placing the wireless transmitter unit within the explosive device.

In an exemplary embodiment according to the invention, the wireless transmitter unit comprises an antenna, which antenna is a coil with a ferrite core. This antenna sets up a magnetic primary field that is only slightly affected by capacitance to the surroundings. In addition, the ferrite core provides up to 25 times higher flux than a corresponding coil without a core, due to the high permeability of the ferrite.

In an exemplary embodiment according to the invention, the ferrite core has a centred opening, through-going in the longitudinal axis, where a mirror is attached in front of one end of the opening and an optical sensor and a light source are attached in front of the other opening, the light source giving an optical signal to the optical sensor via the mirror. In a further embodiment of the invention, the signal to the optical sensor is changed as the ferrite core is wholly or partly destroyed, or is bent, the changes are measured by a measuring device, and the wireless transmitter unit changes its radio frequency characteristic according to the measurements.

In an alternative embodiment according to the invention, one additional coil is provided at one of the ends of the ferrite core, whereby the wireless unit measures the field strength of the antenna signal. In a further embodiment according to the invention, the measured field strength of the antenna signal is changed as the ferrite core is wholly or partly destroyed, or is bent, and the wireless transmitter unit changes its radio frequency characteristic according to the measurements.

In an exemplary embodiment according to the invention, the wireless transmitter unit changes transmission frequency when it changes its radio frequency characteristic according to the measurements.

In an alternative embodiment according to the invention, the wireless transmitter unit changes frequency modulation when it changes its radio frequency characteristic according to the measurements.

In an exemplary embodiment according to the invention, each wireless transmitter unit emits a unique identification signal. In another embodiment according the invention, the wireless transmitter unit is an active or passive RFID chip.

In an exemplary embodiment according to the invention, a wireless receiver unit arranged on a digging implement, e.g., a spade or a grab, connected to a clean-up means, e.g., a digger, a wheel loader or a person, provides an alarm signal as the digging implement approaches a wireless transmitter unit.

Other features and advantages of the invention will be apparent from the following detailed description and attached drawings.

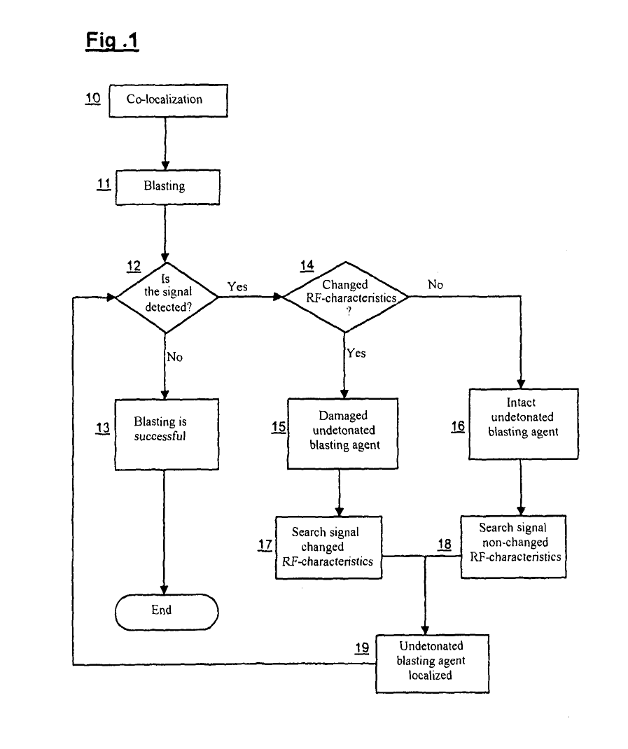

FIG. 1 shows a flow chart of an exemplary method according to the present invention.

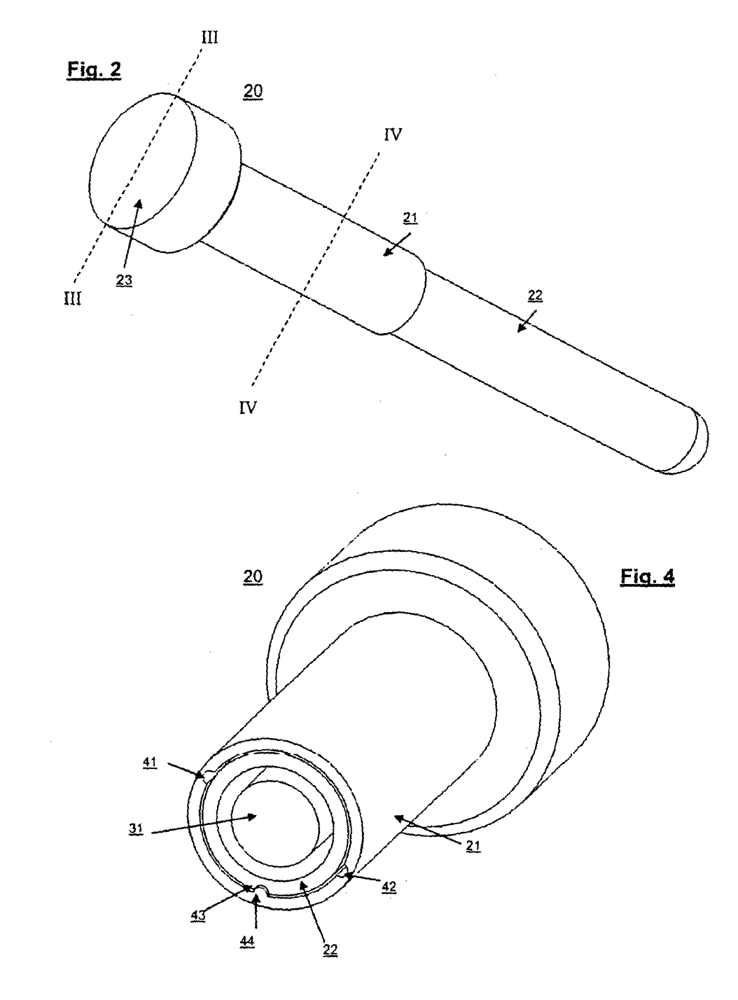

FIG. 2 shows a wireless transmitter unit in an exemplary embodiment.

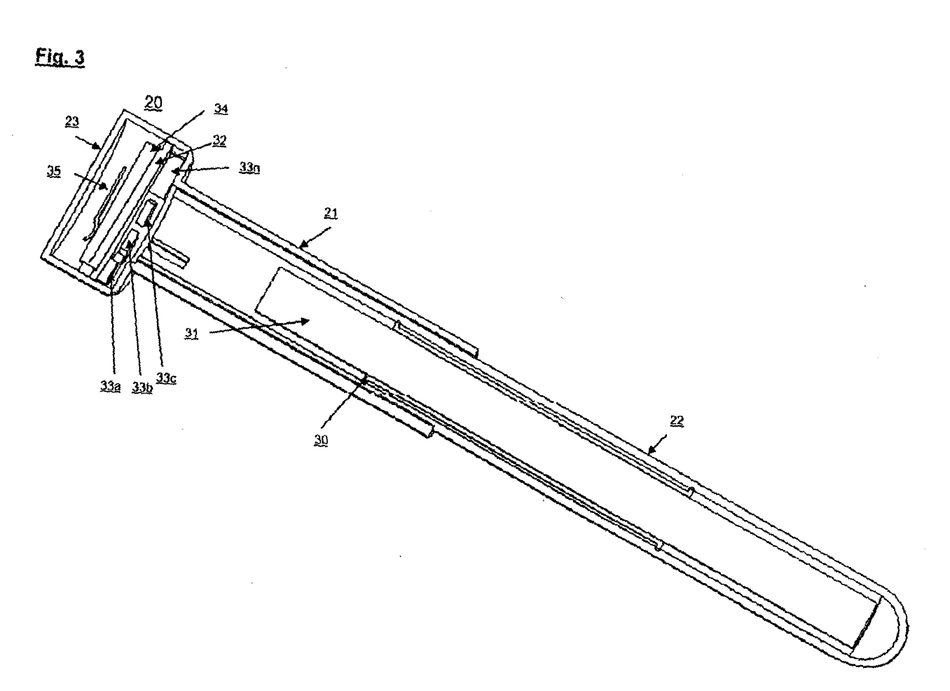

FIG. 3 shows a perspective cross-section taken along the line III-III in FIG. 2.

FIG. 4 shows a cross-section taken along the line IV-IV in FIG. 2.

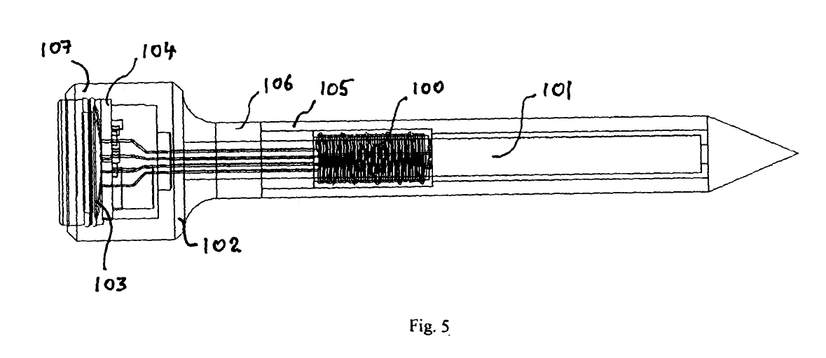

FIG. 5 shows another example of an embodiment of the present invention.

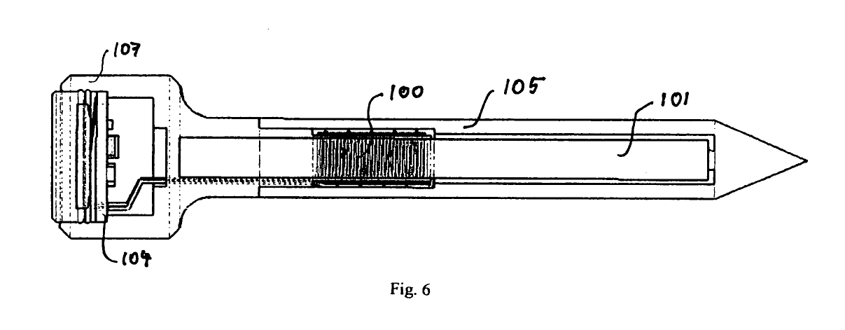

FIG. 6 shows another example of an embodiment of the present invention.

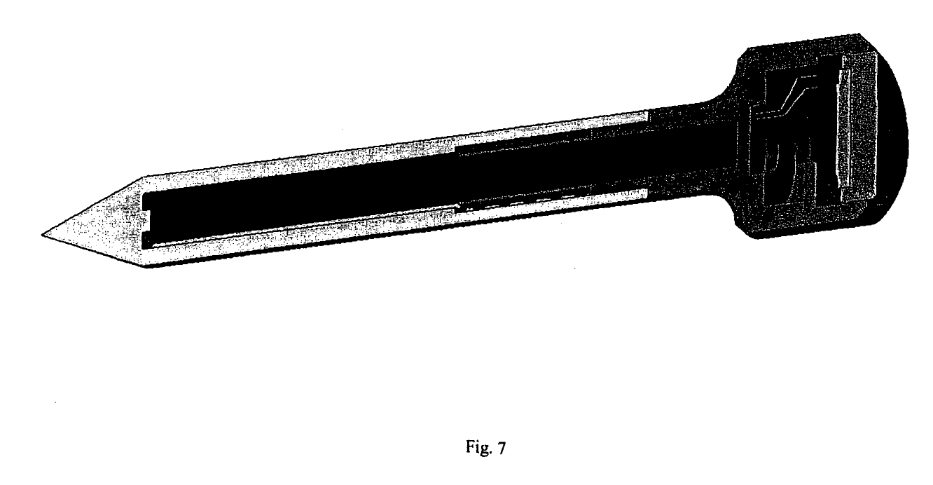

FIG. 7 shows a three-dimensional section of the exemplary embodiment in FIG. 5.

FIG. 1 shows a flow chart of an exemplary method according to the present invention for locating undetonated explosive devices during the clean-up of a blasting area. In the first step 10, a plurality of active or passive wireless units are co-located with respective explosive devices. By means of methods well known to those with knowledge of the field, the explosive devices are set out in the blasting area and a blasting operation is carried out (step 11). If in step 12 no signals are detected by the at least one radio receiver after the blasting operation, the operation has been successful and the explosive devices have destroyed the wireless units, with the result that the wireless units cease to send radio frequency signals (step 13). As the blasting operating is successful, all the explosive devices have been detonated and the blasting area can safely be cleared. In some embodiments, as described below, the wireless transmitter units comprise a device that detects whether the wireless transmitter unit is deformed or partly destroyed. If then in step 12, at least one signal is detected after the blasting operation, it is assessed in step 14 whether the signal has changed radio frequency characteristic compared with the radio frequency characteristic before the blasting operation. When such detection devices are not used, such an assessment is not necessary. If the radio frequency characteristic is not changed, this indicates that there is at least one intact undetonated explosive device in the blasting area (step 16). Then, in step 18, a search is made with the aid of the at least one radio receiver for the at least one wireless transmitter unit with unchanged radio frequency characteristic. Once the wireless transmitter unit is located (step 19), the explosive device is removed or rendered harmless by methods which are well known to those of skill in the art, and the method goes back to step 12. If in step 14 it is indicated that the detected signal has a changed radio frequency characteristic compared with the original signal, this indicates that there is at least one partly damaged explosive device, e.g., broken, bent or the like by other blast debris, in the blasting area (step 15). Then, in step 17, a search is made with the aid of the at least one radio receiver for the at least one wireless transmitter unit with changed radio frequency characteristic. Once the wireless transmitter unit is located, (step 19), the explosive device is removed or rendered harmless by methods well known to those of skill in the art, and the method goes back to step 12. Although the exemplary method is described with reference to the flow chart in FIG. 1, the present invention should not be understood to be limited to the steps or the sequence of the steps in the flow chart. According to the invention, suitable steps can be added or removed, and the sequence of the steps can be changed as appropriate for the use.

According to an exemplary embodiment of the present invention, step 10 comprises joining an initiator for the explosive device to the wireless transmitter unit. The wireless transmitter unit, may, for example, be placed adjacent to the initiator, in proximity to the initiator or be an integral part of the initiator. In a further embodiment according to the invention, step 10 comprises fastening the wireless transmitter unit to the initiator using a sleeve.

According to one alternative exemplary embodiment according to the invention, step 10 comprises mounting the wireless transmitter unit within the explosive device.

FIG. 2 shows an exemplary embodiment of the invention, where the wireless transmitter unit 20 is mounted in two casings, formed of a suitable material, the first casing 21 partly surrounding the second casing 22.

FIG. 3 shows an exemplary embodiment according to the invention, where an antenna is provided on the wireless transmitter unit 20, the antenna comprising a coil 30 and a ferrite core 31. This antenna sets up a magnetic primary field that is only slightly affected by capacitance to the surroundings. In addition, the ferrite core 31 provides an up to 25 times higher flux than the coil 30 would have reached without a core, due to the high permeability of the ferrite. The transmitter unit comprises a circuit board 34, comprising control electronics for the wireless transmitter unit consisting of interconnected discrete components, 33a, 33b, . . . , 33n, battery 34, and battery terminal 35. The discrete components 33a, 33b, . . . , 33n, can be replaced by at least one integral circuit (IC).

FIG. 4 shows a cross section of an exemplary embodiment according to the invention, where longitudinal recesses 41, 42 and a longitudinal projection 44 are formed on the internal face of one of the casings 21, and a longitudinal recess 43 is formed in the external face of the other casing 22. The projection 44 and the recess 43 are reciprocally adapted so that the recess 43 forms a guide groove and the projection 44 forms a guide pin, to facilitate assembly of casing 21 and casing 22. The unused recesses 41, 42 in this example may, for example, be used as wire lead-throughs.

In FIG. 5 it is illustrated how a reaction coil 100 is arranged within a casing tip 105 around a ferrite rod 101. The casing tip 105 is connected to the rear casing 107 which contains a battery and a transmitter, the casing part 105 and the casing part 107 being joined together by an overlapping part 106 as indicated in the figure. In the event of a pressure build-up, the connecting part 106 will be capable of breaking when the pressure around the explosive device exceeds a predetermined threshold. Such a failure or collapse of the connecting part 106 will result in the ferrite rod, for example, being crushed, or that the ferrite rod is intact but the casing part 105 is pushed backwards towards the transmitter and the printed circuit board containing the transmitter electronics 104. This results in the transmitter being destroyed. The casing part can be provided in many types of materials, where elasticity and tensile strength of the individual respective materials can be used to produce a connecting part 106 with desired properties, that is to say, that collapses at a certain surrounding pressure. It is within the scope of this invention that all materials and configurations of joins between the casing parts 105 and 107 can be used in examples of embodiments of the present invention.

In another example of an embodiment of the present invention, a pressure build-up around the transmitter in the rear casing part 107 could result in the collapse of the part 102 in the rear casing part 107 as shown in FIG. 5. Choice of materials and thickness of this collapsing part 102 can be selected so that it breaks at pressures above a defined limit. For example, there may easily be a pressure of as much as 200,000 bar in a borehole, whilst in a neighbouring hole there is virtually no pressure at all. When the collapsing part gives way, the casing part 105 with the ferrite rod can be pressed backwards to meet the printed circuit board 104 with the mounted transmitter. This results in the transmitter ceasing to transmit. A situation of this kind represents minimal risk during clean-up in the blasting area as this situation arises when the initiator goes off. It is only extremely dangerous in the clean-up area if both initiator and dynamite are intact and connected in the casings. If only the dynamite remains, this represents a small risk. In other examples of the embodiment, the collapsing part may be provided as compressed casing parts, and the friction or adhesive forces between the parts can be dimensioned according to a limit for when the collapsing part 102 should give way. It is within the scope of the present invention that each structure which may collapse at a specified pressure that provides an intended effect can be used in examples of an embodiment of the present invention. It is also within the scope of the present invention that a collapsing part can be arranged in any suitable place and manner in a device according to the present invention.

In another example of an embodiment of the present invention, it is the overlapping area between the casing parts 105 and 106 lying around the reaction coil which gives way in the event of an explosion or sufficient pressure build-up. This destroys the coil 100 and the ferrite rod.

Another example of an embodiment of the present invention as shown in FIG. 6 is the casing parts 105 and 107 joined together in an area in which the reaction coil 100 is arranged. As shown in FIG. 6, the joining is effected by passing end parts of the casing parts into each other. A three-dimensional drawing of the embodiment shown in FIG. 6 is shown in FIG. 7. In an example of an embodiment of the present invention, the same overlapping area gives way, but instead of crushing the coil 100 and the ferrite rod 101, the casing part 105 with the ferrite rod 101 is pushed up against the printed circuit board 104 and destroys the transmitter. In an example of an embodiment of the present invention, the casings are made of ABS plastic which has an elastic modulus of about 3000-3500 N/mm². Its tensile strength may be about 75 N/mm². With correctly chosen parameters for these physical properties, a point of collapse can be set.

As mentioned above, the wireless transmitter units in some embodiments comprise a device that detects whether the wireless transmitter unit is deformed or partly destroyed. In an exemplary embodiment, this detection device comprises providing a ferrite core (not shown), the ferrite core having a centred opening, through-going in the longitudinal axis, with a mirror in front of the first end of the opening, and an optical sensor and light source in front of the second end of the opening, the light source giving an optical signal to the optical sensor via the mirror. Deformation or partial destruction of the wireless transmitter unit causes the ferrite core to be bent, or to be wholly or partly destroyed. According to a further embodiment, the detection device measures the changes in the optical signal and changes the radio frequency characteristic according to the measurements, e.g., by changing the transmission frequency or frequency modulation.

In another exemplary embodiment, the detection device comprises providing an additional coil (not shown) at one of the ends of the ferrite core, whereby the wireless transmitter unit measures the field strength of the signal. In an advantageous exemplary embodiment according to the invention, the additional coil is embodied in a circuit board 34, which circuit board 34 comprises control electronics for the wireless transmitter unit. Deformation or partial destruction of the wireless transmitter unit causes the ferrite core to be bent, or to be wholly or partly destroyed. According to an additional embodiment, the detection device measures the changes in the field strength and changes the radio frequency characteristic according to the measurements, e.g., by changing the transmission frequency or frequency modulation.

Referring again to FIG. 1, in an exemplary embodiment according to the invention, the search for the wireless transmitter units in steps 17 and 18 can be done using triangulation.

In an alternative embodiment according to the invention, the search for the wireless units in steps 17 and 18 can be carried out using a single wireless receiver unit with an antenna directionally oriented towards increasing signal strength. This direction-oriented antenna can advantageously be of the same type as, for example, that used in the wireless transmitter unit, consisting of a coil 30 and ferrite core 31.

In an exemplary embodiment, each wireless transmitter unit transmits a unique identification signal that identifies the wireless unit. This may be of help in locating the undetonated explosive devices if, for example, the wireless transmitter units were mapped during the placement of the explosive devices in the blasting area in step 11. A wireless transmitter unit of this kind may, for example, be an active or passive RFID chip.

In a further exemplary embodiment according to the invention, at least one wireless receiver unit is mounted on a digging implement, e.g., a spade or a grab, connected to a clean-up means, e.g., a digger, wheel loader or a person, whereby an alarm signal is provided as the digging implement approaches a wireless transmitter unit.

Referring to FIG. 1, FIG. 2 and FIG. 3, in an exemplary embodiment according to the invention, the two casings 21, 22 are squeezed together to provide electrical contact between a battery and an electric circuit in the wireless transmitter unit 20. In this way, the wireless transmitter unit can be activated as it is placed (step 11) in, e.g., a borehole. Alternatively, the electrical contact is provided by pressing on one of the end faces 23 of the casing 21.

In an exemplary embodiment, an electrically insulating material (not shown) is disposed between one of the battery poles and the electric circuit, e.g., between the battery 34 and the battery terminal 34. The insulating material may, for example, be fastened to one or both casing parts 21, 22 in such manner that the insulating material is pulled way from the pole as the casings are squeezed together, and provides electrical contact with the electric circuit.

9+° In another exemplary embodiment, a hook (not shown) holds a contact, e.g., a battery terminal 35, of one of the battery poles disconnected from the electric circuit. The hook may, for example, be fastened to one or both casing parts 21, 22 in such manner that the contact falls off the hook as the casings are squeezed together, and provides electrical contact with the electric circuit.

A second aspect of the present invention provides an explosive device for use in a system for locating undetonated explosive devices during the clean-up of a blasting area, the explosive device comprising an insertable initiator. In an exemplary embodiment according to the invention, a wireless transmitter unit is fastened to the initiator. In a further exemplary embodiment, the wireless transmitter unit is fastened to the initiator by means of a sleeve. The wireless transmitter unit can, in an exemplary embodiment, comprise one or more features or embodiments of the wireless transmitter units described above.

A third aspect of the present invention provides a system for locating undetonated explosive devices during the clean-up of a blasting area, where a plurality of active or passive wireless transmitter units are used, the respective wireless transmitter units being co-located with the respective wireless transmitter units. In an exemplary embodiment according to the invention, the blasting of an explosive device produces a changed radio frequency characteristic of the respective active or passive wireless transmitter unit in that the blasting destroys the wireless transmitter unit, or in that a device in the wireless transmitter unit detects that the explosive device and the respective co-located wireless transmitter unit have become separated at the blast site as a result of the blasting. The co-location can in an exemplary embodiment comprise one or more features or embodiments of the co-location described above. Furthermore, the wireless transmitter unit can, in an exemplary embodiment, comprise one or more features or embodiments of the wireless transmitter units described above. Lastly, the method in an exemplary embodiment can comprise one or more features of the method described above.

Although features and components of the present invention have been described with reference to specific embodiments in particular combinations, each individual feature or component can be used alone, or in different combinations with or without other features and components according to the present invention.

1. A method for locating undetonated explosive devices during the clean-up of a blasting area, comprising a plurality of active or passive wireless transmitter units, the respective wireless transmitter units being co-located with the respective explosive devices, and where the location of the explosive devices is effected by at least one radio receiver unit that is in radio communication with the respective wireless transmitter units, wherein the method comprises the steps of: assigning a first radio frequency characteristic to the wireless transmitter unit when it is co-located with the explosive device; assigning a second radio frequency characteristic to the wireless transmitter unit as a blasting operation causes destruction of the wireless transmitter unit, or in that a device in the wireless unit detects that the explosive device and the wireless transmitter unit have become separated at the blast site as a result of the blasting operation; and searching for the wireless transmitter unit with the aid of the radio receiver unit; mounting the wireless transmitter unit in two casings, the first casing partly surrounding the second casing.

2. A method as disclosed in claim 1, further comprising squeezing together the first casing and the second casing in order to provide electrical contact between a battery and an electric circuit.

3. A method as disclosed in claim 1, further comprising pressing on one of the end faces of the casing in order to provide electrical contact between a battery and an electric circuit.

4. A method as disclosed in claim 1, further comprising mounting an antenna on the wireless transmitter unit, the antenna comprising a coil with a ferrite core.

5. A method as disclosed in claim 4, further comprising arranging the ferrite core, the ferrite core having a centred opening, through-going in the longitudinal axis, with a mirror in front of one of the ends of the opening and an optical sensor and light source in front of the other end of the opening, the light source giving an optical signal to the optical sensor via the mirror.

6. A method as disclosed in claim 5, further comprising measuring changes in the optical signal as the ferrite core is wholly or partly destroyed, or is bent, and changing the radio frequency characteristic according to the measurements.

7. A method as disclosed in claim 5, further comprising providing an additional coil at one of the ends of the ferrite core, whereby the wireless transmitter unit measures the field strength of the antenna signal.

8. A method as disclosed in claim 7, further comprising embodying the additional coil in a circuit board, the circuit board comprising control electronics for the wireless transmitter unit.

9. A method as disclosed in claim 7, further comprising measuring changes in the field strength as the ferrite core is wholly or partly destroyed, or is bent, and changing the radio frequency characteristic according to the measurements.

10. A method as disclosed in claim 9, further comprising changing transmission frequency according to the measurements.

11. A method as disclosed in 9, further comprising changing frequency modulation according to the measurements.

12. A method as disclosed in claim 1, further comprising transmitting unique identification signals which identify each wireless transmitter unit.

13. A method as disclosed in claim 1, further comprising using triangulation to search for a wireless transmitter unit with the aid of the radio receiver.

14. A method as disclosed in claim 1, further comprising using a single wireless radio receiver unit with a direction-oriented antenna to search for a wireless transmitter unit in the direction of increasing signal strength.

15. A method as disclosed in claim 1, further comprising mounting a wireless receiver unit on a digging implement connected to a clean-up means, whereby an alarm signal is provided as the digging implement approaches a wireless transmission unit.

16. A method as disclosed in claim 15, further comprising fastening the wireless transmitter unit to the detonator using a sleeve.

17. An explosive device for use in a system for locating undetonated explosive devices during the clean-up of blasting area, the explosive device comprising an insertable detonator, wherein a wireless transmitter unit is fastened to the detonator, the wireless transmitter unit being mounted in two casings, where a first of the two casings partly surrounds a second of the two casings.

18. An explosive device as disclosed in claim 17, wherein at least parts of one or both casings collapse in the event of a surrounding pressure that exceeds a given limit, the limit being given by selected or determined material properties of the first and second casing.

19. An explosive device as disclosed in claim 17, wherein the wireless transmitter unit comprises a battery and an electric circuit, and where an electrically insulating material is disposed between one of the battery poles and the electric circuit.

20. An explosive device as disclosed in claim 17, wherein the wireless transmitter unit comprises a battery and an electric circuit, a hook holding a contact of one of the battery poles disconnected from the electric circuit.

21. An explosive device as disclosed in claim 17, wherein the wireless transmitter unit is an active or passive RPID chip further comprising a ferrite core which has a centred opening, through-going in the longitudinal axis, where a mirror is attached in front of a first end of the opening, and an optical sensor and a light source are attached in front of the second end of the opening.

22. An explosive device as disclosed in claim 21, wherein an additional coil is provided at one of the ends of the ferrite core.

23. An explosive device as disclosed in claim 22, wherein the coil is implemented in a circuit board.

24. An explosive device as disclosed in claim 23, wherein the circuit board comprises control electronics for the wireless transmitter unit.

25. An explosive device as disclosed in claim 17, wherein the wireless transmitter unit is an active or passive RPID chip.

26. An explosive device as disclosed in claim 17, wherein the fastening comprises a sleeve.

27. A system for locating undetonated explosive devices during clean-up of a blasting area, comprising a plurality of active or passive wireless transmitter units, the respective wireless transmitter units being co-located with the respective explosive devices, and where the location of undetonated explosive devices is effected by at least one radio receiver unit that is in radio communication with the respective wireless transmitter units, wherein blasting of an explosive device produces a changed radio frequency characteristic in the respective active or passive wireless transmitter unit; the blasting destroys the respective wireless transmitter unit, or a device in the wireless transmitter unit detects that the explosive device and the respective co-located wireless transmitter unit have become separated at the blast site as a result of the blasting.

28. A system as disclosed in claim 27, wherein the co-location is effected by mounting a detonator for the explosive device together with the wireless transmitter unit.

29. A system as disclosed in claim 28, wherein the wireless transmitter unit is an integral part of the detonator.

30. A system as disclosed in claim 27, wherein the co-location is effected by placing the wireless transmitter unit within the explosive device.

31. A system as disclosed in claim 27, wherein the wireless transmitter unit comprises a battery, an electric circuit and a device for connecting the electric circuit to the battery.

32. A system as disclosed in claim 27, wherein the wireless transmitter unit comprises an antenna, which antenna is a coil with a ferrite core.

33. A system as disclosed in claim 32, wherein the ferrite core has a centred opening, through-going in the longitudinal axis, where a mirror is attached in front of a first end of the opening and an optical sensor and a light source are attached in front of a second end of the opening, the light source giving an optical signal to the optical sensor via the mirror.

34. A system as disclosed in claim 33, wherein when the signal to the optical sensor is changed as the ferrite core is wholly or partly destroyed, or is bent, the changes are measured by a measuring device, whereby the wireless unit changes its radio frequency characteristic according to the measurements.

35. A system as disclosed in claim 34, wherein an additional coil is provided at one of the ends of the ferrite core, whereby the wireless unit measures a field strength of the antenna signal.

36. A system as disclosed in claim 34, 35, wherein when the measured field strength of the antenna signal is changed as the ferrite core is wholly or partly destroyed, or is bent, the wireless unit changes its radio frequency characteristic according to the measurements.

37. A system as disclosed in claim 34, wherein when the wireless unit changes its radio frequency characteristic according to the measurements, a transmission frequency is changed.

38. A system as disclosed in claim 34, wherein when the wireless unit changes its radio frequency characteristic according to the measurements, a frequency modulation is changed.

39. A system as disclosed in claim 33, wherein each wireless transmitter unit emits a unique identification signal.

40. A system as disclosed in claim 33, wherein the wireless transmitter unit is an active or passive RFID chip.

41. A system as disclosed in claim 27, wherein a wireless receiver unit mounted on a digging implement connected to a clean-up means is provides an alarm signal as the digging implement approaches a wireless transmitter unit.
